(19) United States
(12) Patent Application Publication
(10) Pub. No.: US 2012/0204695 A1
(43) Pub. Date: Aug. 16, 2012

(54) PUNCH TOOL

(75) Inventors: Ian Johns, Inverness (GB); Graham Briffett, Strathpeffer (GB); John Scott, Inverness (GB)

(73) Assignee: Cilag GmbH International, Zug (CH)

(21) Appl. No.: 13/025,982

(22) Filed: Feb. 11, 2011

(51) Int. Cl. B26D 7/08

(52) U.S. Cl. 83/171

(57) ABSTRACT

The invention provides a punch tool in which heat production by running of the tool is reduced.

### FIELD OF THE INVENTION

The invention relates to an apparatus for punching openings in multi-layer materials. In particular, the invention relates to punches for use in the manufacture of electrochemical test strips.

### BACKGROUND OF THE INVENTION

Designs for test strips suitable for measuring the concentration of an analyte, such as glucose, in a body fluid sample are well known. Typically, these strips have multiple material layers and are manufactured using a continuous web-manufacturing process. In the manufacture of the test strips, it is necessary to punch openings into the multilayer strip in order to produce one or more openings within the strip. For example, one known strip configuration provides a spacer, having an adhesive on one or both surfaces, sandwiched between two layers of metal-coated polyester. When this multi-layer material is processed through a punch tool to create the needed openings within the materials, heat is generated by the punch tool, which heat increases as the process run-time increases. The heat reaches a temperature at which it melts some of the adhesive, which is then transferred to the punch tool resulting in restriction of the punch movement through the guide plate, material and die. As the adhesive continues to accumulate, the tool may become damaged. To avoid this, the manufacturing process must be stopped periodically to enable the punch tool to be stripped down and cleaned interrupting production of a full batch of test strips. This production line down-time results in a significant yield loss.

### BRIEF DESCRIPTION OF THE DRAWINGS

FIG. 1 is a front view of a punch tool of the invention in a module within a continuous manufacturing line.

FIG. 2 is a perspective view of the tool of FIG. 1.

FIG. 3 is a magnified perspective view of a portion of the tool of FIG. 2.

FIG. 4 is a cross-sectional view of the punch tool of FIG. 1.

FIG. 4a is an exploded view of the punch tool of FIG. 1.

FIG. 5 is a top plan view of a top plate used in the punch tool of FIG. 1.

FIG. 6 is a top plan view of a guide plate used in the punch tool of FIG. 1.

FIG. 7 is a top plan view of a die plate used in the punch tool of FIG. 1.

FIG. 8 is a top plan view of a base plate of a bottom plate used in the punch tool of FIG. 1.

### DETAILED DESCRIPTION OF THE INVENTION

The invention provides a punch tool apparatus, and process for manufacturing using the punch tool, in which accumulation of adhesive from the material being cut is minimized. The punch tool of the invention may find its greatest utility in the manufacture of multi-layer materials, such as electrochemical-based test strips, in which an opening must be cut into the material.

It is a discovery of the invention that, by reducing the production of heat during the running of the punch tool, the accumulation of adhesive on the punch tool may be minimized providing higher process yields and extending the life of the tool. In the tool of the invention, heat reduction is achieved by cooling the tool using a water cooling system. Additionally, and preferably, the punch tool incorporates a spring-loaded top plate to minimize vertical movement of the material passing through the tool during the punching process and reducing friction and heat within the tool. Still additionally and preferably, the punches used in the tool are coated. Finally and more preferably, the tool of the invention additionally includes a device for monitoring the punching force providing a method for detecting increases in friction before the tool or web material is damaged.

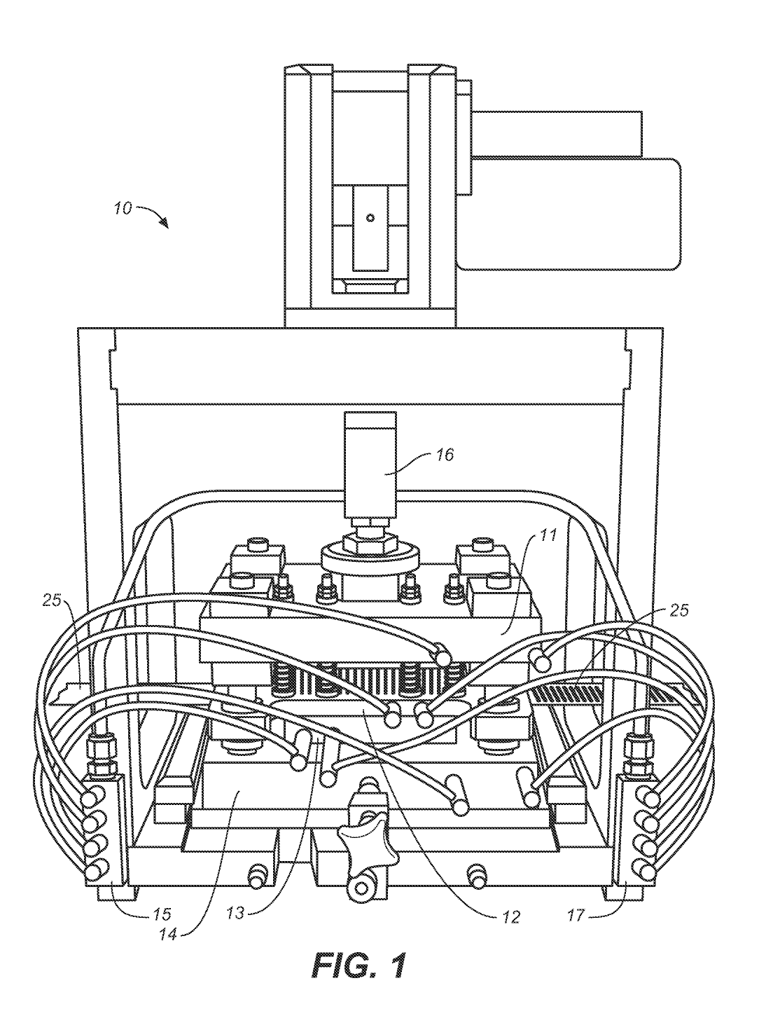

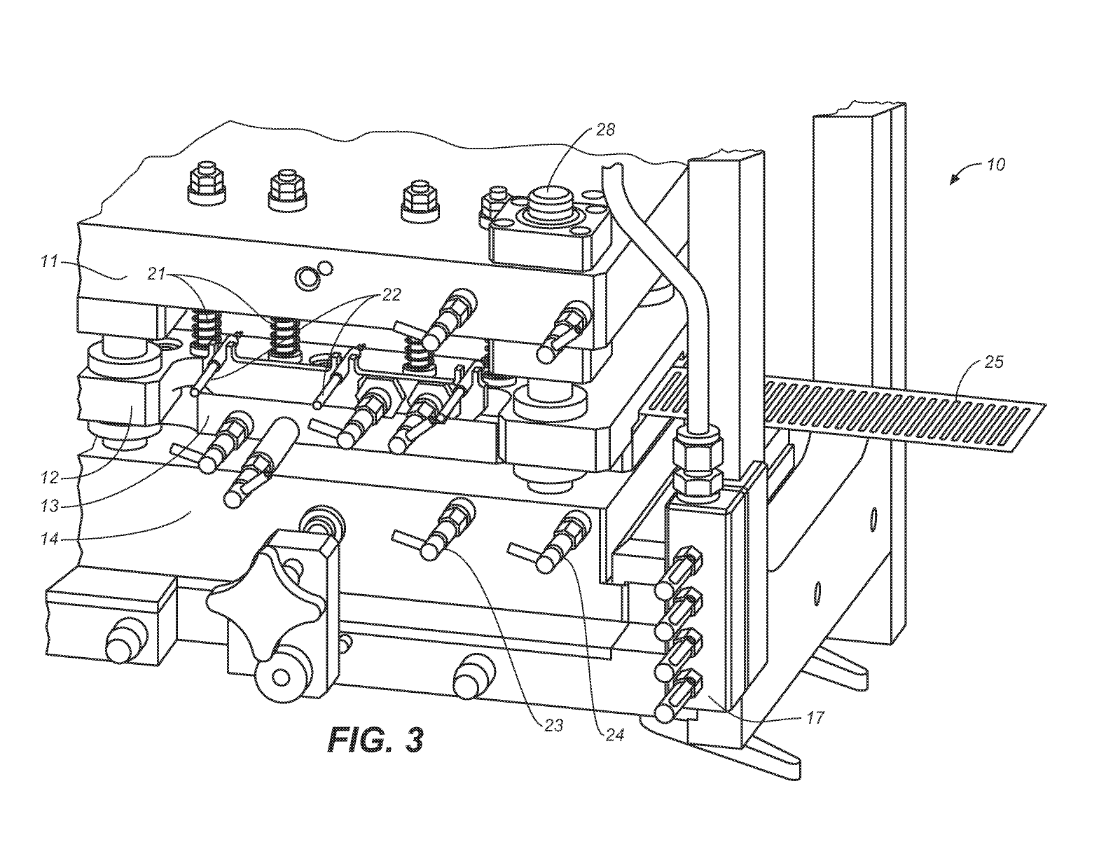

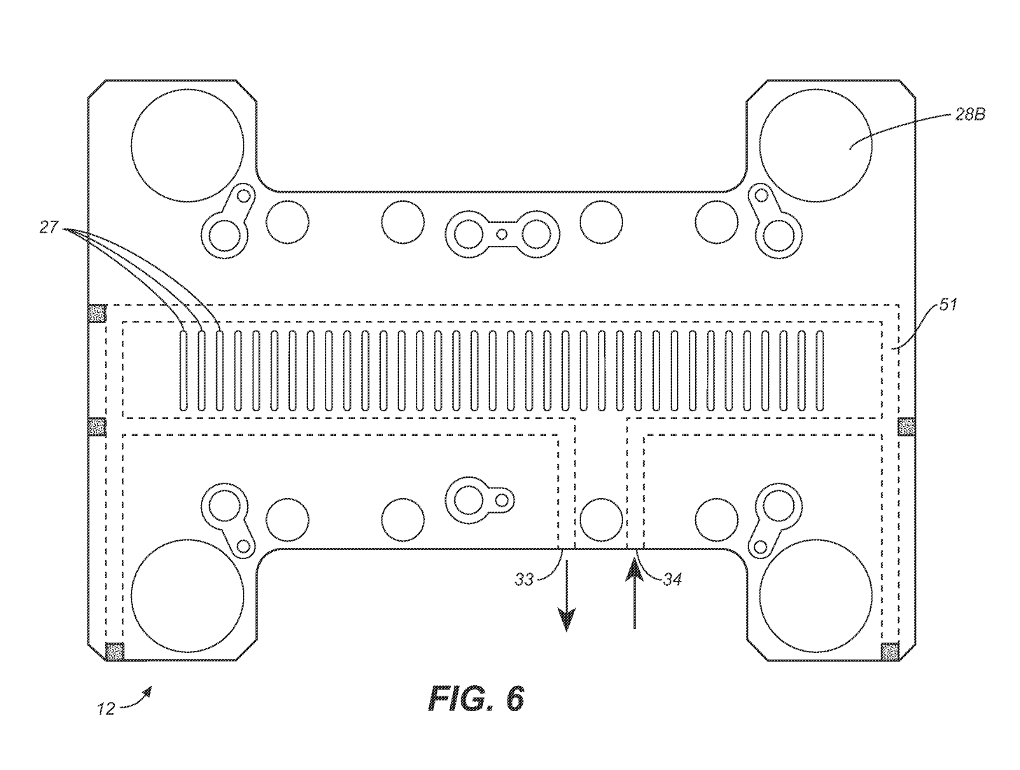

In FIGS. 1 through 8 is depicted punch tool 10 of the invention incorporated into a module that forms a part of a continuous manufacturing line. Punch tool 10 has a top plate 11 with guide plate 12 movably attached thereto. Also shown is die 13 movably disposed on bottom plate 14. Cooling water in-feed 17 and cooling water out-feed 15, circulate water to the interiors of the top plate, guide plate, die and bottom plate. The components of the tool may be made of any suitable, wear-resistant material.

Top plate 11, guide plate 12, die 13 and bottom plate 14 are mounted on pillars 28. Except for the bottom plate and die, each of these parts moves upwardly and downwardly along the pillars as the punching process takes place. Preferably, there are four pillars provided to maintain the alignment of the guide plate and punches to the die plate. The tool may be driven upwardly and downwardly on the pillars by any suitable drive mechanism including, without limitation, an eccentric cam and a precision servo mechanism. Typically, the drive mechanism must be suitable to generate a force in excess of 6400 N.

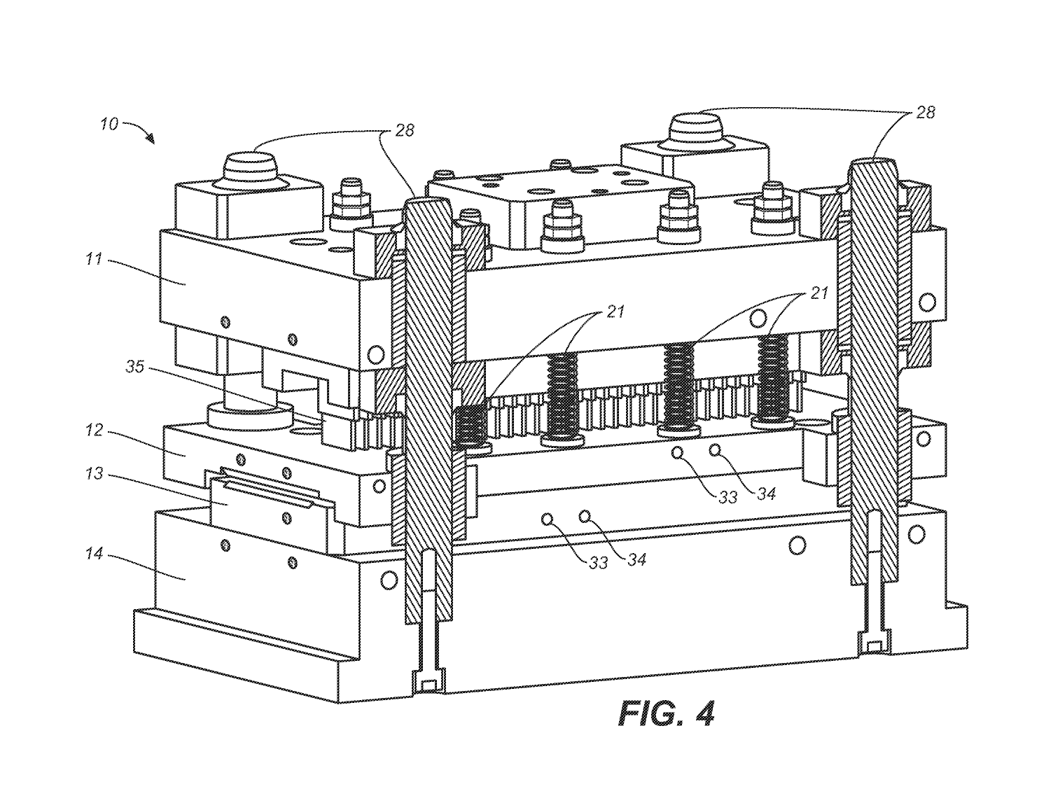

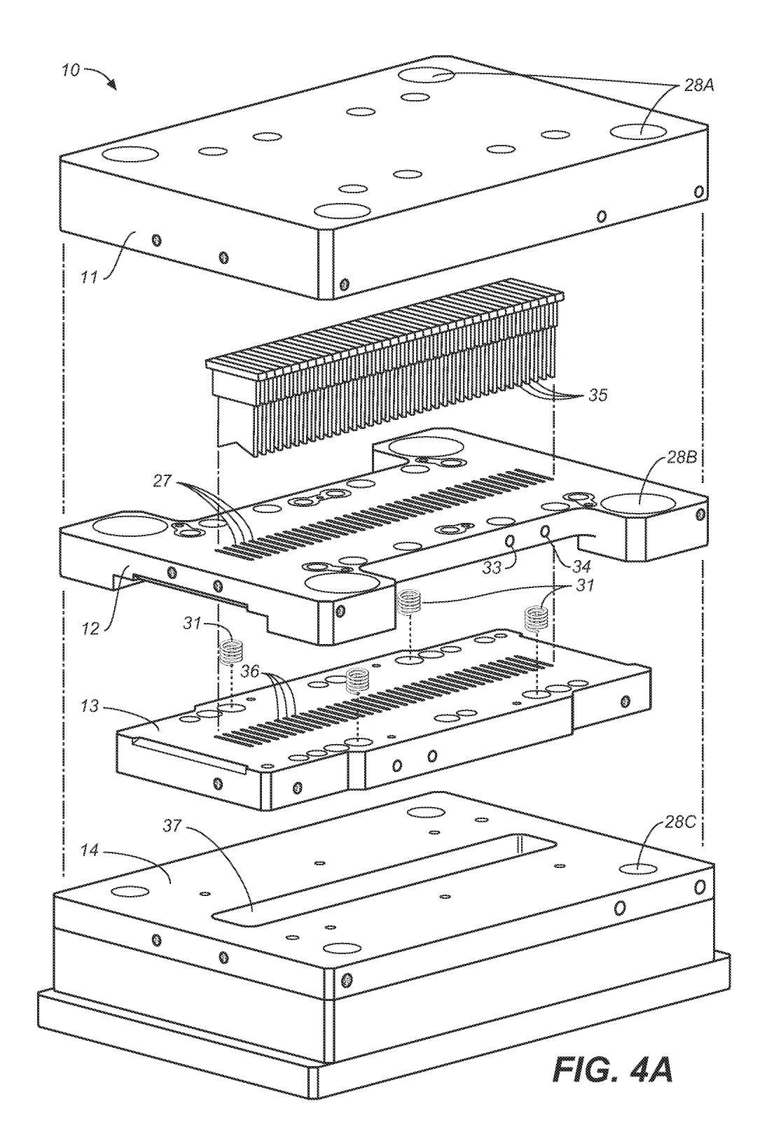

A plurality of punches 35, as shown in FIG. 4, are fixedly arrayed on the bottom surface of top plate 11. Preferably, the punches are coated with a suitable wear-resistant and friction-reducing coating. One example of such a coating is the ARMOLOY™ TDC coating available from the Armoloy Corporation.

As top plate 11 reciprocates upwardly and downwardly, each of the plurality of punches passes through one of a plurality of openings 27, as shown in FIG. 4a, in guide plate 12, each of which openings corresponds to the dimensions and locations of one of the plurality of punches. Guide plate 12 serves to accurately position the punches relative to each other and the web of material that passes below the bottom surface of guide plate 12 and ensures the desired dimensions and tolerances are achieved for the openings to be cut into the web material.

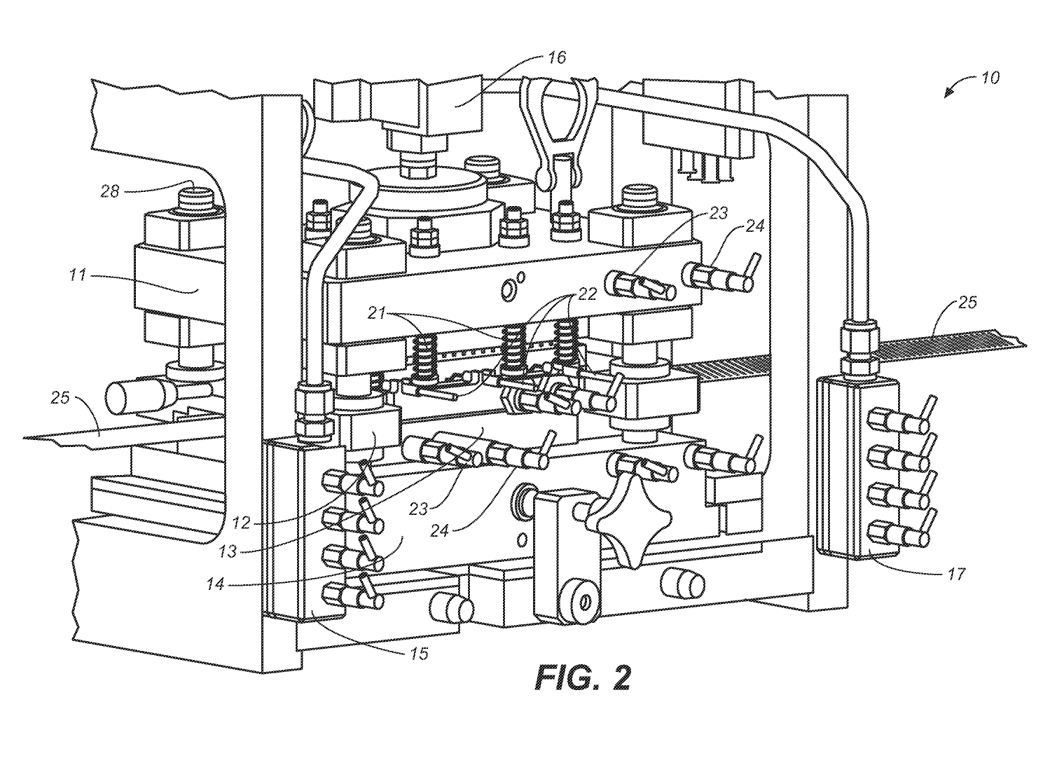

Top plate 11 is spring-loaded onto guide plate 12. Preferably and as shown in FIGS. 2, 4, and 4a, eight long springs 21 with a spring rate of 26.35 N/mm are used that have a preload of 8 mm and a travel of 18 mm. For purposes of the invention, by “long spring” is meant that the spring is longer than the springs described as the “short springs.” Each long spring provides a force of 474 N resulting in a total compression force for the springs of 3792 N. Also and preferably, four small springs 31, as shown in FIG. 4a, are used which are located below guide plate 12. The short springs preferably have a spring rate of 13.25 N/mm and a preload of 4 mm with a total travel of 5.5 mm. The four short springs preferably generate a force of 73 N and have a total compression force of 292 N.

The springs act to hold the web stable during the punch process reducing friction and heat generation. Guide plate 12 is pushed downwardly by the springs during the punch cycle onto a fixed stop, the thickness of which stop may be altered to reduce the clearance between the web and guide plate. In this way, guide plate 12 serves as a ceiling to prevent excessive distortion in the material. That is, the guide plate moves downwardly, preferably to within about 20 mu of the top surface of the web material. This acts to reduce the punch force needed and reduces hear build-up in the tool.

As shown in FIGS. 1 and 2, punch load cell 16 is provided on the top surface of top plate 11 for continuously monitoring the load on the punches. Load cell 16 may be any suitable commercially available load cell, such as such as a DMGZ 300 Series 20 KN available from FMS Force Measuring System AG. The data from the cell is sent to a supervisory control and data system. When the punch pull out force increases significantly, preferably when it increases above 500 N, this indicates that excessive adhesive has built-up on the punches and the guide plate. This results in an increase in friction and the forces required to open the tool after punching through the web. Thus, at this point, the line should be stopped and the tool disassembled and cleaned.

The web of material 25 passes over the top surface of die plate 13, which plate sits atop of bottom plate 14. Bottom plate r 14 supports the assembly of the die plate, guide plate and top plate during punching of the web material. Top surface of die plate 13 has a plurality of recesses 36 therein, the position of each of which openings corresponds to an opening within guide plate 12 so that, as a punch penetrates through the web material, the recess accepts the punches. Preferably, these waste slugs are removed from the tool by any convenient method such as by vacuum. Cut-out 37 in the bottom plate permits waste slugs to be extracted after the punches have passed through the web.

With reference to FIG. 1 through 3, temperature probes 22 preferably are affixed in recesses within and along the edge of top surface of guide plate 12. The number and position of the probes will be determined by the size and punch process of the tool. More preferably, three probes are used, one in the approximate center and two at or near either end of the guide plate. The probes monitor the temperature of the guide plate and send the data to the control system where, if the temperature rises above about 18° C. the operator will be notified.

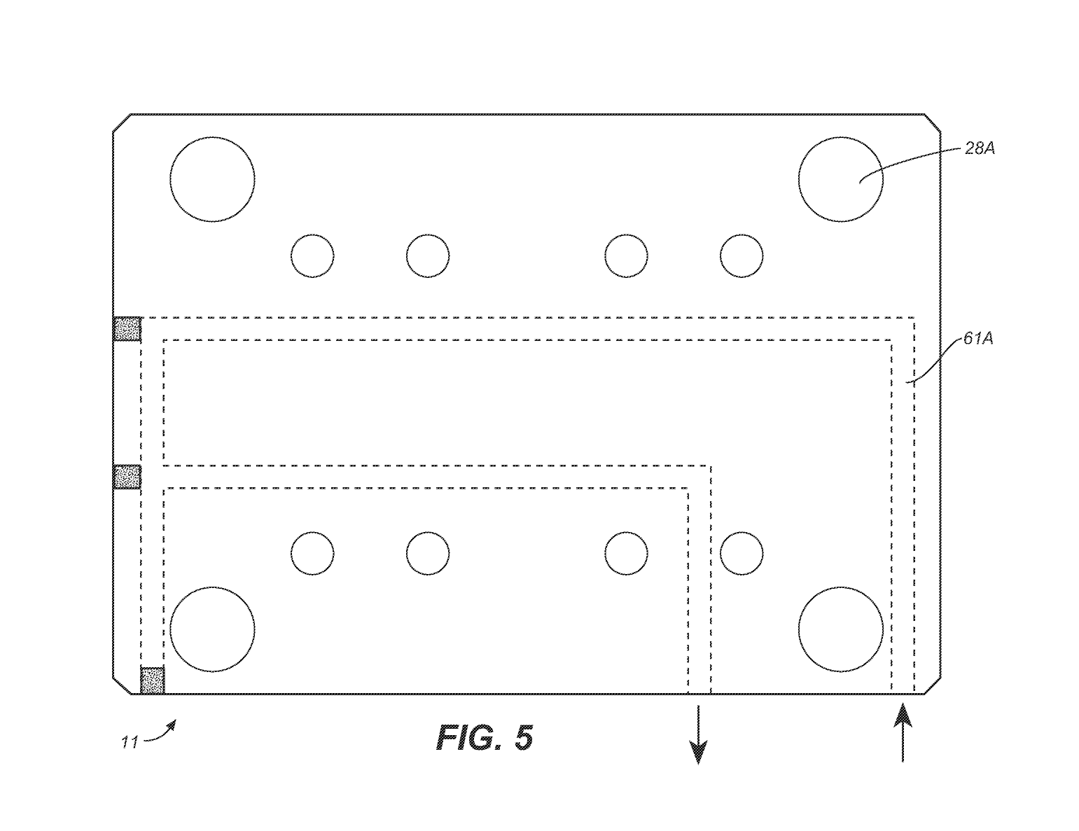

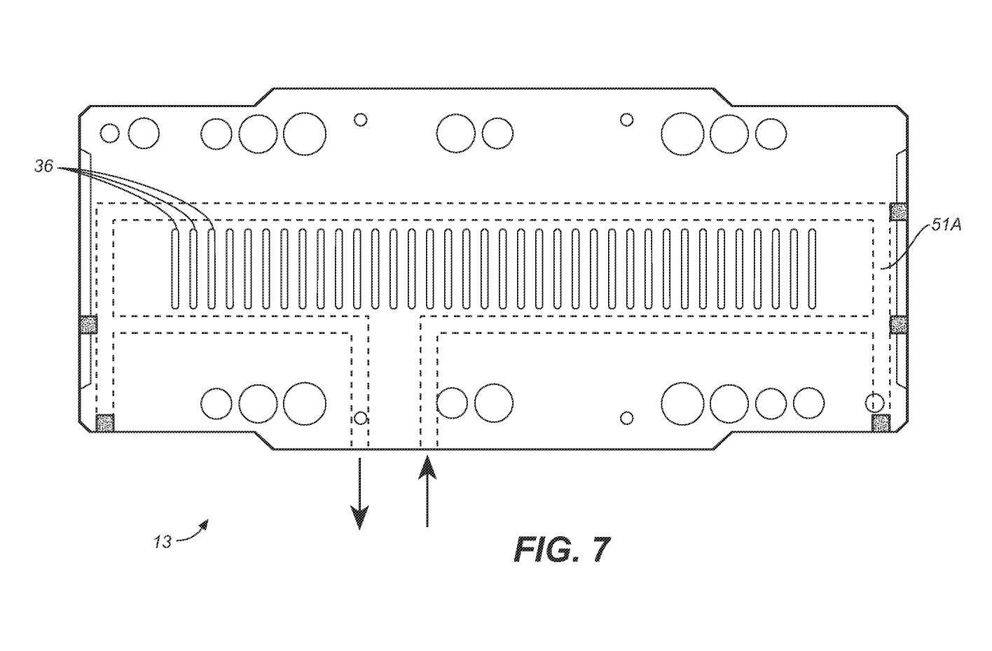

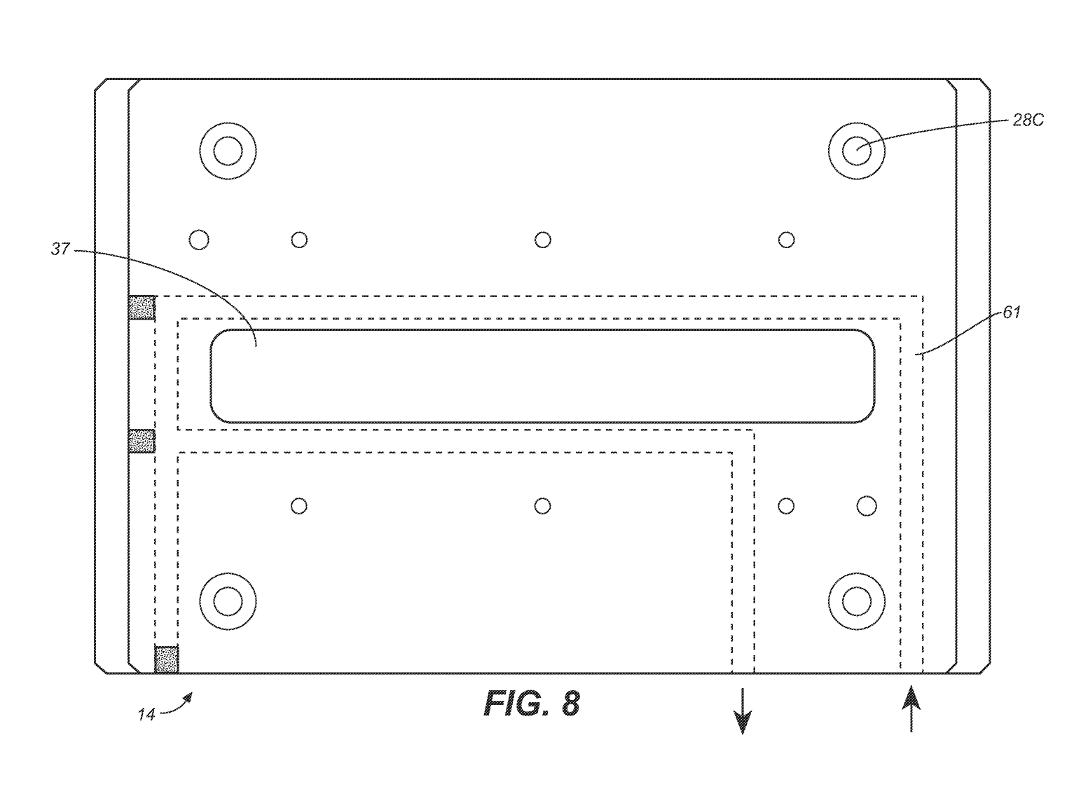

During operation of the punch tool, cooling water at a temperature of about 5 to about 18° C. flowing at a rate of up to about 60 liters per minute and at a maximum pressure of about 3.8 bar flows into channels within the interior of each of the top plate, guide plate, die plate and bottom plate. A direction that the flow of water may take is shown by the arrows in FIG. 5 through 8. The channels are located and configured in any manner so that they achieve the result of removing as much heat as desired yet the structural integrity of the plates and bottom plate is maintained. For example, in FIGS. 7 and 8 are shown guide plate 12 and bottom plate 14, respectively, with channels 51 and 61, respectively, therein. The water flow acts to ensure that the temperature of these components is maintained at a temperature above the dew point, but sufficiently cool so as to minimize the heat generated from the friction caused by the punch passing through the web material. Preferably, the temperature of these components is maintained between about 10 and 15° C. Any suitable temperature controller may be used in the water cooling mechanism of the tool including, without limitation, a GWK TECO CW25 mold temperature controller.

The punch tool of the invention may be used in any suitable manufacturing process including a process for manufacturing a test strip or measuring one or more analytes in blood. Using the enzyme ink of the invention may be manufactured using any convenient, known method including, without limitation, web printing, screen printing and combinations thereof. For example, the strip may be manufactured by sequential, aligned formation of three layers, or films; two outer layers each coated on one side with a metal and forming the electrodes and a middle layer, spacer layer coated with adhesive on one or both sides.

An exemplary manufacturing process is as follows. The substrate used for each of the layers may be nylon, polycarbonate, polyimide, polyvinyl chloride, polyethylene, polypropylene, glycolated polyester, polyester and combinations thereof. Preferably, the substrate is a polyester, more preferably MELINEX™, manufactured by DuPont Teijin Films. One or more of the two substrates forming the outer layers may be coated to improves stability as for example by application of a sodium 2-mercapto-ethane-sulphonate coating as well as being preconditioned to reduce the amount of expansion and stretch that can occur in the strip manufacturing process.

Metals, such as gold or palladium or any combination thereof, may be sputtered onto the substrate surface. Additionally, reagents that react with the analyte to be measured and that help to generate a current signal are dispensed onto, for example, the palladium surface. The two outer layers are then laminated to the middle layer.

This processing takes place using continuous rolls, or webs, of the various materials and results in a roll of the laminated materials. This laminated roll is then sent through the punch tool as well as a through a cutting machine for formation of the individual test strips.

What is claimed is:

1. A punch tool comprising a bottom plate, die plate, guide plate, and top plate wherein at least one of the plates comprises channels therein permitting the circulation of water at a temperature of about 5 to about 18° C. therein.

2. The tool of claim 1, wherein the bottom plate, die plate, top plate and guide plate comprise channels therein permitting the circulation of water at a temperature of about 5 to about 18° C. therein

3. The tool of claims 1 and 2, wherein the top plate is spring-loaded onto the guide plate.

4. The tool of claim 3, further comprising eight long springs and four small springs.

5. The tool of claims 1 and 2, further comprising a fixed stop for the guide plate that stops the guide plate about 20 mu of a top surface of a web material.

6. The tool of claim 3, further comprising a fixed stop for the guide plate that stops the guide plate about 20 mu of a top surface of a web material.

7. The tool of claim 5, further comprising a monitoring device suitable for monitoring a load on a plurality of punches.

8. The tool of claim 6, further comprising a monitoring device suitable for monitoring a load on a plurality of punches.

9. The tool of claim 7, wherein the plurality of punches are coated with a wear-resistant and friction-reducing coating.

10. The tool of claim 8, wherein the plurality of punches are coated with a wear-resistant and friction-reducing coating.
